(19) United States
(12) Patent Application Publication
(10) Pub. No.: US 2011/0147411 A1
(43) Pub. Date: Jun. 23, 2011

(54) PINCH MANIFOLD

(75) Inventors: Andres Bernal, Sunny Isles Beach, FL (US); Faustino Poo, Miami, FL (US)

(73) Assignee: UNIVERSITY OF MIAMI, Miami, FL (US)

(21) Appl. No.: 13/059,033

(22) PCT Filed: Aug. 12, 2008
(86) PCT No.: PCT/US08/72864

§ 371 Date: Feb. 14, 2011

(51) Int. Cl. B67D 7/06

(52) U.S. Cl. 222/1; 222/544

(57) ABSTRACT

The present invention includes substance delivery control system having a first conduit defining a lumen for the passage of a substance therethrough; a first delivery control element defining a first conduit state selection element; a second delivery control element defining a second conduit state selection element, where the alignment of the first and second conduit state selection elements places the conduit in a first state, and where misalignment of the first and second conduit state selection elements places the conduit in a second state.

### FIELD OF THE INVENTION

The present invention relates to a method and system for selecting and regulating fluid flow through one or more conduits, and in particular, a non-contact fluid control device.

### BACKGROUND OF THE INVENTION

Many medical and industrial applications involve handling or otherwise processing hazardous, sterile, or toxic fluids or substances that could damage machine components or result in the contamination of the substance being handled. For example, reduced or no-contact devices are largely used in biological/chemical fluid processing to prevent the unwanted interaction between processing components and the fluids themselves. The use of such minimally-interactive devices is also widespread in the food and beverage industry where sterility of fluids and/or their corroding affects on machine parts also pose a concern.

Devices typically used in such situations include non-contact valves, with the solenoid pinch-valve being the most common. A pinch valve generally includes a flexible conduit in a normal or relaxed state having a fluid flow path through it. A pinch mechanism operates to pinch or otherwise collapse the conduit, thereby interrupting the fluid flow therethrough. Pinch mechanisms for controlling fluid flow through a conduit range from relatively simple, manually operated screw-type devices to more complex motor or solenoid operated devices controlled by electric signals.

In applications involving the management of a variety of fluids or conduits at the same time, the operation and automated control of solenoid pinch-valves can be problematic and unreliable. For example, non-contact fluid manifolds with automated controls using electrical pinch-valves controlled by solenoids to regulate fluid flow are complex and prone to failure. A solenoid valve requires an electrical current to remain opened or closed, depending if it is normally closed (“NC”) or normally open “NO”). A prevalent problem occurs when electric current through a solenoid is interrupted, resulting in the electrically-induced closed or open-state of the valve being compromised. Such a failure may result in the unintended dispensing, mixing, or movement of the substances being handled, leading to losses of time and materials, compromising safety and efficiency, and creating potentially hazardous conditions.

In addition, a prevalent approach for the use of automated no-contact manifold includes the use of arrays of individual solenoid pinch valves individually controlled with accompanying electronics. Other approaches involve complex cam arrangements and require at least two active elements (a motor and a solenoid) to function, and may entail a significant number of mechanical elements. Moreover, as the solenoids must also draw electrical current in addition to the motor, the overall power consumption of such a system may be undesirably high. Further, such designs are only cost effective when a large number of equivalent individual pinch valves are needed, making it difficult and costly to scale down or otherwise adapt the typical system to particularized applications.

In view of the above, it is desirable to provide a substance delivery control system that is scalable, cost-effective, reduces the complexities and numbers of components, is not susceptible to failures from power interruption, and further reduces the amount of electrical power required for operation. It would further be desirable to provide a substance delivery control system operable to controllably modify or regulate the substance flow to a desired degree.

### SUMMARY OF THE INVENTION

The present invention advantageously provides a substance delivery control system that is scalable, cost-effective, reduces the complexities and numbers of components, is not susceptible to failures from power interruption, and further reduces the amount of electrical power required for operation.

In particular, the present invention provides a substance delivery control system having a first conduit defining a lumen for the passage of a substance therethrough; a first delivery control element defining a first conduit state selection element; a second delivery control element defining a second conduit state selection element, where the alignment of the first and second conduit state selection elements places the conduit in a first state, and where misalignment of the first and second conduit state selection elements places the conduit in a second state. The first delivery control element may define a substantially disc-like shape having a first radius about a substantial portion of a circumference thereof, where the first conduit state selection element includes a first circumferential segment of the first delivery control element having a second radius different from the first radius. In a particular example, the second radius may be less than the first radius.

The second delivery control element may also define a substantially disc-like shape having a third radius about a substantial portion of a circumference thereof, where, the second conduit state selection element includes a second circumferential segment of the second delivery control element having a fourth radius different from and/or less than the third radius.

The first state of the conduit may allow passage of a substance therethrough, while the second state of the conduit may substantially prevent passage of a substance therethrough. In addition, the first delivery control element may be selectively rotatably engageable with the second delivery control element. For example, the first delivery control element may be independently rotatable with respect to the second delivery control element about a first predefined range, and the first delivery control element may not be independently rotatable with respect to the second delivery control element beyond the first predefined range.

The present invention also provides a substance delivery control system, including a first conduit defining a lumen for the passage of a substance therethrough, the conduit having a first state allowing passage of a substance therethrough, and a second state substantially preventing passage of a substance therethrough; a first delivery control element defining a substantially disc-like shape having a first radius about a substantial portion of a circumference thereof, the first delivery control element also defining a first circumferential segment having a second radius different from the first radius; a second delivery control element defining a substantially disc-like shape having a third radius about a substantial portion of a circumference thereof, the second delivery control element also defining a second circumferential segment having a fourth radius different from the third radius; where the alignment of the first and second circumferential segments places the conduit in the first state, and where misalignment of the first and second circumferential segments places the conduit in the second state. A compression element may be interposed between the first and second delivery control elements and the conduit. The first delivery control element may be selectively rotatably engageable with the second delivery control element, and the first delivery control element may be independently rotatable with respect to the second delivery control element about a first predefined range, and not independently rotatable with respect to the second delivery control element beyond the first predefined range.

The system may also include a second conduit defining a second lumen for the passage of a substance therethrough, the second conduit having a first state allowing passage of a substance therethrough and a second state substantially preventing passage of a substance therethrough. In particular, the alignment of the first and second circumferential segments may place the second conduit in the first state, and misalignment of the first and second circumferential segments may place the second conduit in the second state.

The present invention also provides a method of controlling the passage of a substance through a conduit, including aligning a first circumferential segment of a first delivery control element, a second circumferential segment of a second delivery control element, and a first compression element, where the alignment of the first and second circumferential segments with the first compression element allows the passage of a substance through a first conduit adjacent the first compression element; misaligning the first and second circumferential segments, where the misalignment causes the first compression element to restrict the passage of the substance through the first conduit; and aligning the first circumferential segment, the second circumferential segment, and a second compression element, where the alignment of the first and second circumferential segments with the second compression element allows the passage of a substance through a second conduit adjacent the second compression element. The misalignment may be accomplished at least in part by rotating the first circumferential segment a first predefined range independently of the second circumferential segment, and the alignment of the first and second circumferential segments with the second compression element may be achieved at least in part by rotating the first and second circumferential segments together in a first direction, and then rotating the first circumferential segment independently of the second circumferential segment in a second direction. The method may further include partially compressing or obstructing the conduit, for example by partial rotation of the first disk to accurately control the percentage or degree of compression of the selected conduit.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an assembly view of an embodiment of a substance delivery control system constructed in accordance with the principles of the present invention;

FIG. 2 is a front view of an embodiment of a substance delivery control system constructed in accordance with the principles of the present invention;

FIG. 3 is a cross-sectional side view of an embodiment of a substance delivery control system constructed in accordance with the principles of the present invention;

FIG. 4 is a perspective view of a subassembly of an embodiment of a substance delivery control system constructed in accordance with the principles of the present invention;

FIG. 5 is an additional perspective view of a subassembly of an embodiment of a substance delivery control system constructed in accordance with the principles of the present invention;

FIG. 6 is an illustration of an operation sequence for an embodiment of a substance delivery control system constructed in accordance with the principles of the present invention; and

FIG. 7 is an additional illustration of an operation sequence for an embodiment of a substance delivery control system constructed in accordance with the principles of the present invention.

### DETAILED DESCRIPTION OF THE INVENTION

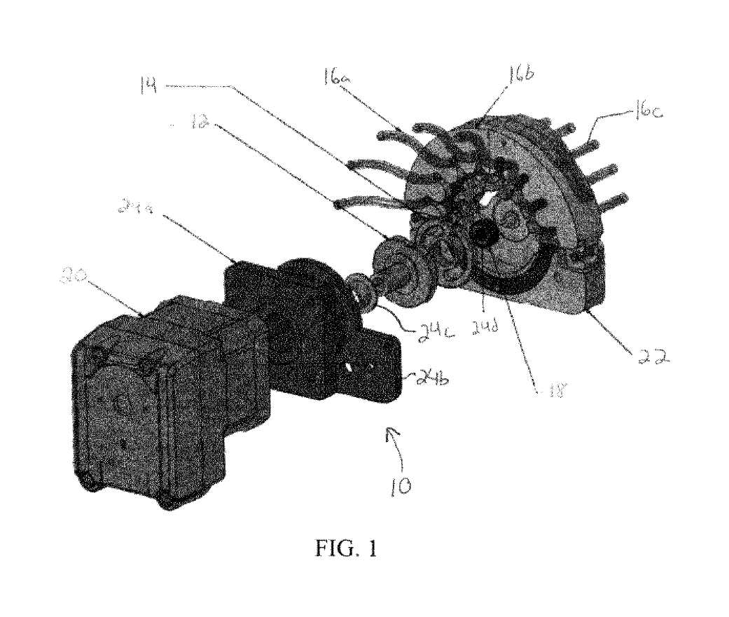

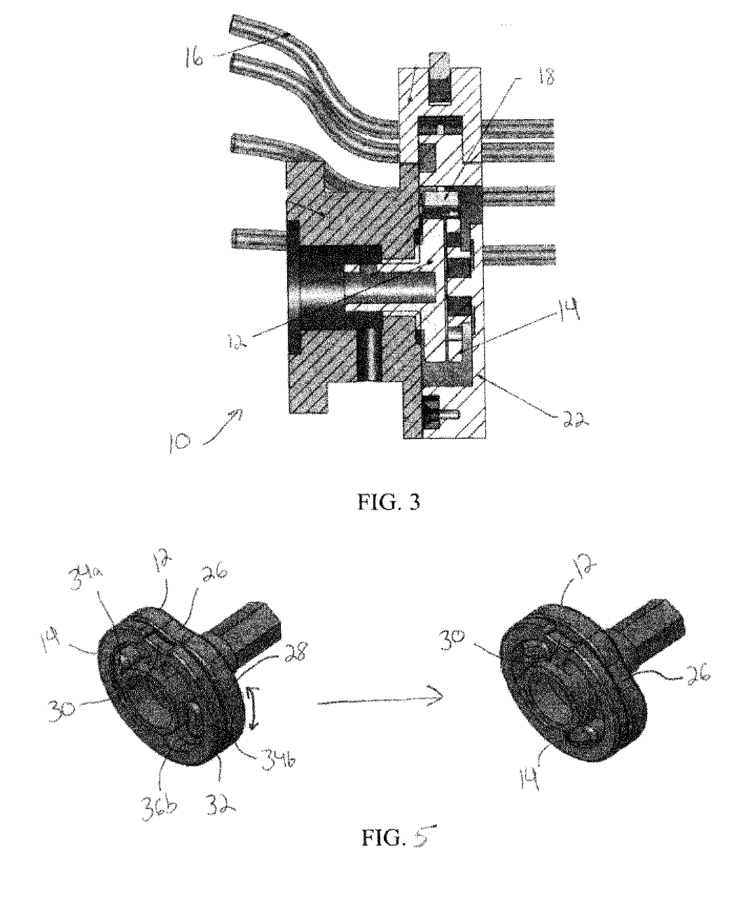

The present invention advantageously provides a substance delivery control system that is scalable, cost-effective, reduces the complexities and numbers of components, is not susceptible to failures from power interruption, and further reduces the amount of electrical power required for operation. Now referring to the figures, there is shown in FIGS. 1-3 an embodiment of a substance delivery control system 10 constructed in accordance with the principles of the present invention. In particular, the substance delivery control system 10 may generally include a plurality of delivery control elements, such as a first delivery control element 12 and a second delivery control element 14, movable with respect to one another to open, close, or otherwise affect one or more conduits 16 and thus the flow or movement of a substance therethrough. The system may also include one or more compression elements 18 interacting with the delivery control elements to compress or otherwise engage the conduits 16. The substance delivery control system 10 may also generally include an actuation element or driver 20, such as a motor, coupled to the plurality of delivery control elements for the movement and manipulation thereof. A housing 22 as well as one or more coupling components, bushings, bearings or the like 24a, 24b, 24c, 24d may also be included in the assembly of the substance delivery control system 10.

Primarily, the substance delivery control system 10 may include one or more conduits 16 defining internal lumens or passageways for the movement or flow of substances or fluids. The one or more conduits 16 may include piping, tubing, or the like, and may further be flexible, collapsible, or otherwise physically manipulable to allow, obstruct, or otherwise control the passage of fluids or substances therethrough. The conduits 16 may be connected to or otherwise in communication with a source of substance or fluid (not shown), and the conduits 16 may further be coupled to a pump, vacuum, or pressure source creating a bias and/or differential within the conduits 16 to cause the fluids or substances therein to move from a first location to a second location along the length of the conduit. The conduits 16 may be radially arranged within a housing, manifold, or cassette, and may further be in contact with or otherwise engageable with the compression elements 18, delivery control elements 12,14 and the like as described below.

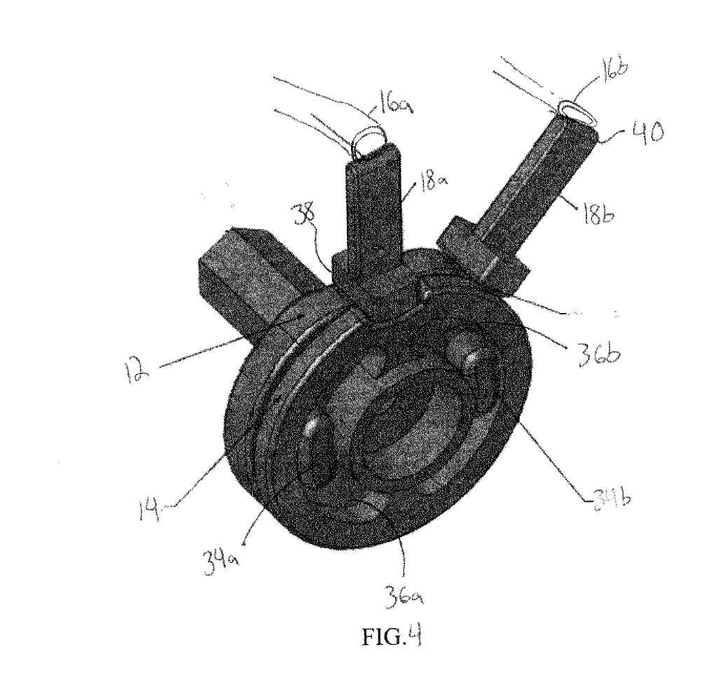

Now referring to FIGS. 4 and 5, the substance delivery control system 10 of the present invention includes the first and second delivery control elements 12,14 which are operable to directly or indirectly (through an intermediate linkage or element, for example) selectively obstruct or allow the movement of substances or fluids through the conduits 16a, 16b. In particular, either of the first and second delivery control elements 12, 14 may include a rotatable member, such as a substantially disc-shaped body, rotor, cam or the like. For example, the first delivery control element 12 may generally define a disc-like shape having a substantially uniform radius about a majority of its circumference. In similar fashion, the second delivery control element 14 may also generally define a disc-like shape with a substantially uniform radius about a majority of its circumference.

Each of the first and second delivery control elements may also define a conduit state selection feature or element for selectively allowing or obstructing the passage of substances through the conduit. For example, the first delivery control element 12 may define a first circumferential segment 26, such as a depression, notch or the like, in its outer circumference having a radius different from a substantial remainder of the circumference 28 of the first delivery control element 12. Alternatively, the first circumferential segment 26 may have a radius larger than that of the substantial remainder of the circumference 28 of the first delivery control element 12, such as a projection, jut, or the like (not shown). Moreover, the second delivery control element 14 may define a second circumferential segment 30, such as a depression, notch or the like, in its outer circumference having a radius different from a substantial remainder of the circumference 32 of the second delivery control element 14. Alternatively, the second circumferential segment 30 may have a radius larger than that of the substantial remainder of the circumference of the second delivery control element 14, such as a projection, jut, or the like (not shown).

The first and second delivery control elements 12,14 may be at least partially rotatable with respect to one another. The first and second delivery control elements 12, 14 may also be engageably rotatable with one another, that is, they may be movable in sync with or otherwise rotated in unison with one another along a particular range of motion. For example, the first delivery control element 12 may define one or more protrusions 34a, 34b on a side surface, while the second delivery control element 14 may include one or more openings, apertures, or the like 36a, 36b through a side surface. The protrusions 34a, 34b of the first delivery control element 12 may be positionable within or through the openings 36a, 36b in the second delivery control element 14. The openings 36a, 36b of the second delivery control element 14 may have a larger dimension or size than that of the protrusions, thereby allowing for a certain degree of independent movement of the protrusions of the first delivery control element 12 within the openings. The size of the openings 36a, 36b (and the protrusions) defines a range of motion that the protrusions 34a, 34b, and thus the first delivery control element 12, may move independently of the second delivery control element 14, and thus may be modified or selected to achieve the desired range of independent movement for any given application. When movement of the protrusions 34a, 34b causes a portion of the protrusions to abut or otherwise contact an endpoint or wall of the openings 36a, 36b, further movement of the protrusions (and thus the first delivery control element 12) causes a movement of the second delivery control element 14, as discussed in more detail below.

As shown in FIGS. 4 and 5, the protrusions 34a, 34b may have a contoured shape, including for example a radially-arcuate side easing circular or rotatable movement about a centered circular feature of the second delivery control element 14, and the openings 36a, 36b in the second delivery control element 14 may be partially arcuate or contoured as well. It is understood that the illustrated shapes are merely examples, and that a myriad of shapes and/or mechanical linkages such as selectably engageable gears, teeth, or the like, may be incorporated to achieve the described articulation between the two components.

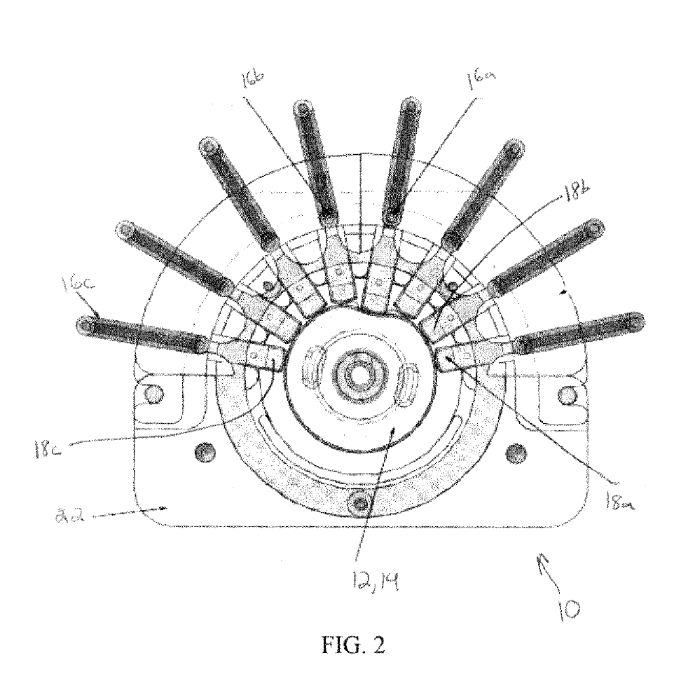

Referring now to FIGS. 2-4, the substance delivery control system 10 can also include one or more compression elements 18a, 18b, 18c . . . that are operable to compress, deform, or otherwise collapse the one or more conduits 16a, 16b, 16c . . . of the system, thereby operating to selectively allow or restrict the movement of substances through the conduits. In particular, each compression element may generally define an elongate body having a first end 38 engageable with either and/or both of the first and second delivery control elements 12,14 as well as a second end 40 engageable with or otherwise movable to abut or apply a force to the conduits. The first end 38 of the compression element may have a width or shape complimentary to that of the respective circumferential segments 26,30 of the first and second delivery control elements 12,14. For example, when the first and second circumferential segments 26,30 of the first and second delivery control elements are aligned, the first end 38 of the compression element may rest on or otherwise be positionable within or on the first and second circumferential segments. In an embodiment where the first and second circumferential segments have a radius less than that of their remaining circumferences, the compression element may sink into or otherwise recede into the aligned segments. Should the first and second circumferential segments have a radius greater than that of their remaining circumferences, the compression element may be raised or otherwise ascend onto the aligned segments. Accordingly, the first and second circumferential segments 26,30 of the first and second delivery control elements 12,14 are operable to selectively move the one or more compression elements towards or away from the conduits 16, resulting in the selective compression or relaxation of the conduits 16.

As shown in FIG. 1, the substance delivery control system 10 of the present invention also includes a driver or motor 20 for actuating the movement of the first and/or second delivery control elements. In particular, the motor may be engageable with or otherwise coupled to the first delivery control element 12 either directly or through an intermediate linkage, mounting, or the similar coupling. The motor may affect or otherwise control the movement of the second delivery control element 14 through the selective movement of the first delivery control element 12 and thus the manipulation or movement of the protrusions 34a, 34b of the first delivery control element 12 and their engagement with the openings 36a, 36b or other structure of the second delivery control element 14.

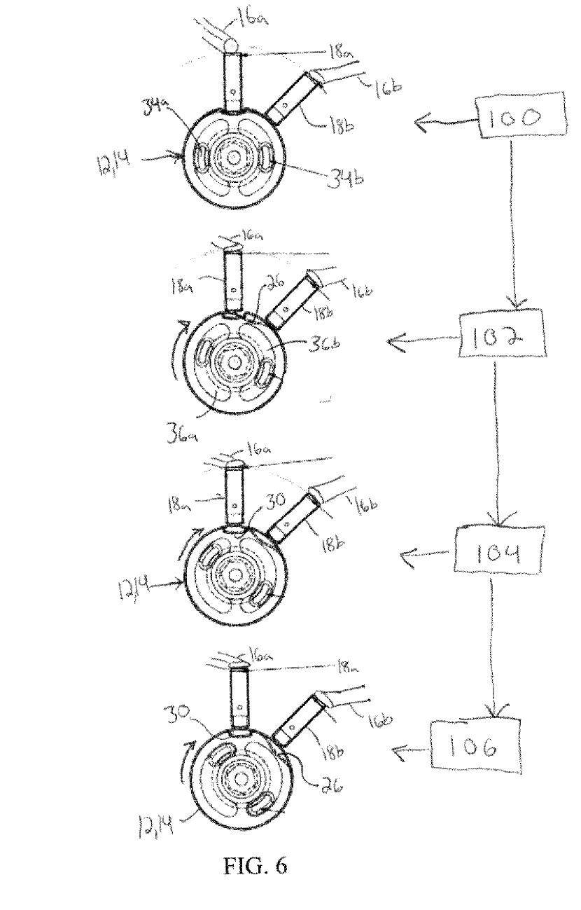

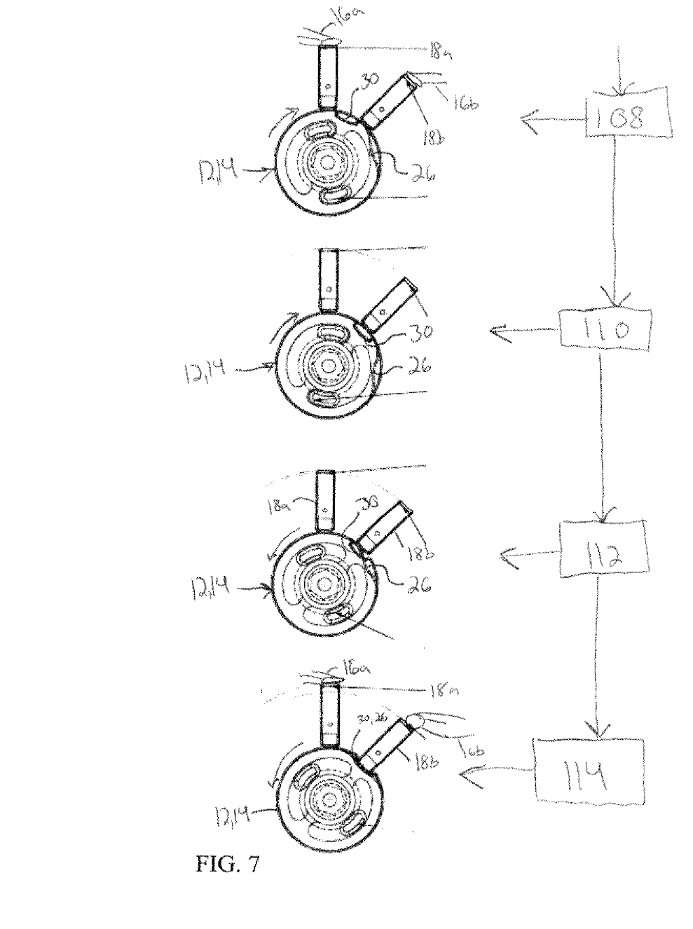

Now referring to FIGS. 6-7, an exemplary method of using the substance delivery control system 10 of the present invention is shown. In particular, step 100 shows the first and second delivery control elements 12,14 positioned such that their respective first and second circumferential segments are aligned or “in-phase.” The alignment of the first and second circumferential segments (here shown as portions segments having radii less than a substantial portion of the remainder of the circumferences of the first and second delivery control elements) allows a first compression element 18a to recede into the aligned circumferential segments. This recession or downward position of the first compression element 18a causes it to move away from the conduit 16a it is selectively engageable with. Accordingly, the conduit 16a may be relaxed or its internal lumen may be uncompromised or unobstructed, thereby allowing fluid or substances to travel therethrough, i.e., the conduit is in an “open position.”

In step 102, the first delivery control element 12 is rotated in a first direction (clockwise, for example). Because the first delivery control element 12 is at least partially independently rotatable with respect to the second delivery control element 14 (due to the sizing and/or interaction between the protrusions 34a, 34b of the first delivery control element 12 with the openings 36a 36b of the second delivery control element 14, for example), the rotation of the first delivery control element 12 within a particular range does not affect the positioning of the second delivery control element 14. The rotation of the first delivery control element 12, however, causes the displacement or movement of the first circumferential segment 26, resulting in the misalignment or “out-of-phase” positioning between the first and second circumferential segments of the first and second delivery control elements 12,14. As the first compression element 18a may include a dimension or width that spans the width or dimension of both the first and second delivery control elements, movement of the first delivery control element 12 and the resulting misalignment of the circumferential segments causes the first compression element 18a to raise onto the larger-radius circumference portion of the first delivery control element 12. This raising or extending causes the movement of the first compression element 18a towards a particular conduit 16a, and results in the first compression element 18a abutting, collapsing, or otherwise imparting a force onto the conduit 16a. This collapsing, abutting or the like causes the restriction or collapsing of the internal lumen of the conduit 16a, thereby preventing fluids or substances from moving through it, i.e., the conduit 16a is placed in a “closed' position. It is also contemplated that the first and second circumferential elements may be partially in-phase and partially out-of-phase to control or regulate the flow or movement of substances through the conduit to a specified degree.

In step 104, the first delivery control element 12 is further rotated to a position (independently of the second delivery control element 14) such that the first circumferential segment 26 is adjacent a second compression element 18b operating with respect to a second conduit. However, as the second delivery control element 14, and thus the second circumferential segment 30, have remained in a static position, the positioning of the first circumferential segment 26 beneath the second compression element 18b does not affect the closed position of the second conduit. In step 106, the first delivery control element 12 has been rotated to a point where further rotation will cause the first and second delivery control elements to rotate in unison with one another. For example, the first delivery control element 12 has been rotated to a position where the protrusions 34a, 34b abut an end wall of the openings 36a, 36b of the second delivery control element 14, and thus imparting additional rotative force or movement to the first delivery control element 12 will cause the second delivery control element 14 to rotate as well. Although the first and second delivery control elements are rotating together, because their respective circumferential segments remain misaligned, the compressions elements 18a, 18b remain extended and thus the conduits 16 remain closed.

In steps 108 and 110, the first and second delivery control elements are rotated to a position where the second circumferential segment 30 of the second delivery control element 14 is adjacent the second compression element 18b. Again, as the first and second circumferential segments remain misaligned, the positioning of the second circumferential segment 30 adjacent to or beneath the second compression element 18b does not affect the extended position and thus the closed state of the second conduit 16b.

In steps 112 and 114, the first delivery control element 12 is rotated in a second direction (counter-clockwise, for example), thus de-coupling from the second delivery control element 14. Resulting from the selectively engageable rotational relationship between the first and second delivery control element 14s (such through the interaction of the protrusions with the openings), the movement of the first delivery control element 12 in the second direction does not affect the position of the second delivery control element 14, and in particular, the positioning of the second circumferential segment 30 adjacent the second compression element. The first delivery control element 12 is rotated in the second direction until the first circumferential segment 26 is also adjacent or underneath the second compression element 18b. As this position aligns the first and second circumferential elements or otherwise places them “in-phase,” the second compression element 18b recedes into the aligned circumferential segments. This recession or downward position of the second compression element 18b causes it to move away from the second conduit 16b it is selectively engageable with. Accordingly, the second conduit 16b may be relaxed or its internal lumen may be uncompromised or unobstructed, thereby allowing fluid or substances to travel therethrough, i.e., the conduit is in an “open position.”

As illustrated and described, the manipulation of the first and second delivery control elements provides for the selective opening or closing of particular conduits, and thus the controlled delivery, movement, or passage of fluids or substance therethrough. The described device and steps may be repeated as desired for any number of conduits or cycles to control or select the delivery or passage of substances through the conduits. Also, although the above description sets forth a device where the alignment of the circumferential segments provides for the opening of the conduits, the converse may also be used where it is desirable to have one or more conduits in a normally open state, and the alignment of the circumferential segments causes the conduits to close. This can be achieved, for example, as described above where the circumferential elements include radii greater than a substantial remainder of the respective circumferences of the delivery control elements.

Moreover, while the system has been described with an intermediate, compression element disposed between the delivery control elements and the conduits to be controlled, it is contemplated that the delivery control elements may interact directly with the conduits for the selective control thereof. For example, the circumferential segments may directly abut or otherwise come into contact with the conduits for the selective compression or collapse thereof.

The fluid control device described herein may include a single drive element (a motor or manual actuation component), which simplifies the construction and use, and also allows for cost-competitive manufacturing. Further, unlike traditional solenoid valves, the present device is not susceptible to unintended operation or actuation resulting from power failure, e.g., the described device will remain in a particular position or orientation regardless of the stage of electrical current flow. This also results in reduced power consumption compared to solenoid pinch valves needing constant current to maintain their active positions. The reduced electrical requirements also reduces the heat generated with solenoid valve use, which may compromise or otherwise have a detrimental impact on heat sensitive substances such as enzymes or the like passing through the controlled conduits.

The present device is also readily scalable to any number of channels or conduits and virtually any size of tubing, while solenoid valves are not easy to scale because of power and heat dissipation requirements. Overall, the fluid control device described herein provides a practical, cost effective replacement of individual pinch-valve arrays/manifolds that is more reliable and less susceptible to the drawbacks of conventionally-available systems.

Moreover, although described primarily in a biological setting or application, the present invention may be equally applicable in virtually any automated (aseptic or not) dispensing and/or proportioning system in biological, chemical, medical, laboratory, pharmacological and/or food and beverage industries. For example, the described device may be used for or otherwise integrated with blood analyzers, dialysis machines, multidrug delivery systems, peristaltic pump systems, surgical suction lines for body fluids, dispensing/filling systems for viscous, corrosive or radioactive fluids; nucleic acid analysis; media or antibody production, automated dispensing/mixing of food/beverage items, adhesive/Stain/Paint/Solvent dispensing that could otherwise damage regular contact valve parts.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1-19. (canceled)

20. A substance delivery control system, comprising:
a first conduit defining a lumen for the passage of a substance therethrough;
a first delivery control element defining a first conduit state selection element; and
a second delivery control element defining a second conduit state selection element,
wherein the alignment of the first and second conduit state selection elements places the conduit in a first state allowing passage of the substance, and wherein misalignment of the first and second conduit state selection elements compresses the conduit into a second state inhibiting passage of the substance.

21. The system according to claim 20, wherein the first delivery control element defines a substantially disc-like shape having a first radius about a substantial portion of a circumference thereof.

22. The system according to claim 21, wherein the first conduit state selection element includes a first circumferential segment of the first delivery control element having a second radius different from the first radius.

23. The system according to claim 22, wherein the second radius is less than the first radius.

24. The system according to claim 22, wherein the second delivery control element defines a substantially disc-like shape having a third radius about a substantial portion of a circumference thereof.

25. The system according to claim 24, wherein the second conduit state selection element includes a second circumferential segment of the second delivery control element having a fourth radius different from the third radius.

26. The system according to claim 25, wherein the fourth radius is less than the third radius.

27. The system according to claim 20, wherein the first delivery control element is selectively rotatably engageable with the second delivery control element.

28. The system according to claim 20, wherein the first delivery control element is independently rotatable with respect to the second delivery control element about a first predefined range, and wherein the first delivery control element is not independently rotatable with respect to the second delivery control element beyond the first predefined range.

29. The system according to claim 20, further comprising a plurality of conduits radially arranged around the first delivery control element.

30. The system according to claim 20, further comprising a motor connected to at least one of the first and second delivery control elements.

31. A substance delivery system, comprising:
a first substantially disc-like delivery control element defining a first notch; and
a second substantially disc-like delivery control element defining a second notch;
a plurality of conduits radially-arranged around the first and second delivery control elements, each conduit defining a lumen for the passage of a substance therethrough and having a first state allowing passage of a substance therethrough, and a second state substantially preventing passage of a substance therethrough;
wherein the alignment of the first and second notches places at least one of the conduits of the plurality of conduits in the first state, and wherein misalignment of the first and second notches places the conduit in the second state.

32. The system according to claim 31, further comprising a compression element movably disposed between the first and second delivery control elements and at least one of the conduits.

33. The system according to claim 32, wherein alignment of the first and second notches with the compression element places the at least one conduit in the first state, and wherein misalignment of at least one of the first and second notches with the compression element causes compression of the at least one conduit to place the at least one conduit in the seconds state.

34. The system according to claim 31, wherein the first delivery control element is selectively rotatably engageable with the second delivery control element.

35. The system according to claim 31, wherein the first delivery control element is independently rotatable with respect to the second delivery control element about a first predefined range, and wherein the first delivery control element is not independently rotatable with respect to the second delivery control element beyond the first predefined range.

36. The system according to claim 31, further comprising an actuation element coupled to at least one of the first and second delivery control elements for the controllable rotation thereof.

37. A method of controlling the passage of a substance through a conduit, comprising:
aligning a first circumferential segment of a first delivery control element, a second circumferential segment of a second delivery control element, and a first compression element, wherein the alignment of the first and second circumferential segments with the first compression element allows the passage of a substance through a first conduit adjacent the first compression element;
misaligning the first and second circumferential segments, wherein the misalignment causes the first compression element to restrict the passage of the substance through the first conduit; and
aligning the first circumferential segment, the second circumferential segment, and a second compression element, wherein the alignment of the first and second circumferential segments with the second compression element allows the passage of a substance through a second conduit adjacent the second compression element.

38. The method of claim 37, wherein the misalignment is accomplished at least in part by rotating the first circumferential segment a first predefined range independently of the second circumferential segment.

39. The method of claim 37, wherein the alignment of the first and second circumferential segments with the second compression element is achieved at least in part by rotating the first and second circumferential segments together in a first direction, and then rotating the first circumferential segment independently of the second circumferential segment in a second direction.
